(19) United States
(12) Patent Application Publication
(10) Pub. No.: US 2012/0208525 A1
(43) Pub. Date: Aug. 16, 2012

(54) COMPACT BASE STATION AND PROGRAM

(75) Inventor: Eiji Mochida, Osaka-shi (JP)

(73) Assignee: SUMITOMO ELECTRIC INDUSTRIES, LTD., Osaka-shi (JP)

(21) Appl. No.: 13/503,528

(22) PCT Filed: Oct. 28, 2010
(86) PCT No.: PCT/JP2010/069156

§ 371 Date: Apr. 23, 2012

(30) Foreign Application Priority Data
Nov. 9, 2009 (JP) 2009-255928

(51) Int. Cl. H04W 24/02

(52) U.S. Cl. 455/422.1

(57) ABSTRACT

An object of the present invention is to provide a compact base station and a program that can inform a user of communication quality of uplink communication in mobile communication. A compact base station of the present invention is a femtocell base station 100 having a transmitting and receiving unit 110 that performs wireless communication with a mobile terminal 200, and includes a measuring unit 120 that measures communication quality of uplink communication from the mobile terminal 200 to the femtocell base station 100, based on an uplink signal received by the transmitting and receiving unit 110 from the mobile terminal 200; and a quality informing unit 130 that allows an output unit 150, 250 to inform of the communication quality measured by the measuring unit 120, the output unit 150, 250 performing informing output to a user.

### TECHNICAL FIELD

The present invention relates to a compact base station for mobile communication and a program.

### BACKGROUND ART

Due to the development of wireless communication technologies in recent years, wireless communication networks such as mobile phone communication networks have commonly proliferated. However, such wireless communication has a problem that a wireless communication line cannot be maintained or communication quality deteriorates depending on the radio wave reception conditions. Hence, the construction of a communication system is considered in which compact base stations are individually installed in a radio shadow area and particularly in a location where communication quality needs to be secured.

In this communication system, compact base stations for indoor use such as a picocell and a femtocell having a call area with a radius of the order of several tens of meters (hereinafter, these compact base stations are referred to as “femtocell base stations”) are installed and perform wireless communication with mobile phone terminals.

Since this communication is connected to a core network of a mobile phone using a wired communication line to which a femtocell base station is connected, the mobile phone terminal can communicate with a mobile phone communication network through the femtocell base station.

The following Patent Literature 1 discloses a communication system using a radio base station connected to an optical communication network. By using this communication system, signals from a mobile phone used in a subscriber's home can be connected to various networks such as an IP network, a general telephone switching network, or a mobile communication switching network from the radio base station through the optical communication network.

### CITATION LIST

### Patent Literature

Patent Literature 1: Japanese Unexamined Patent Publication No. 2004-15103

### SUMMARY OF INVENTION

### Technical Problem

In mobile communication using a mobile terminal such as a mobile phone terminal, communication quality of downlink communication where communication is performed from a base station to the mobile terminal is notified to a user on the mobile terminal. However, in this notification, the communication quality of uplink communication where communication is performed from the mobile terminal to the base station is not notified to the user.

In communication using a conventional macrocell base station, when the downlink quality is poor, the uplink quality is often poor, and thus, it is sufficient to only display the communication quality of downlink communication and the communication quality of uplink communication does not need to be separately displayed.

However, in communication using a femtocell base station, the communication quality of downlink communication and the communication quality of uplink communication may greatly vary and thus there is a problem that a user cannot know the communication quality of uplink communication only by being notified of the communication quality of downlink communication.

The present invention has been made in view of such circumstances and an object thereof is to provide a compact base station and a program that are capable of informing a user of the communication quality of uplink communication in mobile communication.

### Solution to Problem

A first aspect of the present invention provides a compact base station having a transmitting and receiving unit that performs wireless communication with a mobile terminal, the compact base station including: measuring means for measuring communication quality of uplink communication from the mobile terminal to the compact base station, based on an uplink signal received by the transmitting and receiving unit from the mobile terminal; and quality informing means for allowing an output unit to inform of the communication quality measured by the measuring means, the output unit performing informing output to a user.

According to the compact base station according to the first aspect, the measuring means measures the communication quality of uplink communication from a mobile terminal to the compact base station, based on an uplink signal received by the transmitting and receiving unit from the mobile terminal, and the quality informing means allows the output unit that performs informing output to a user to inform of the communication quality obtained by the measurement.

Therefore, by using the compact base station according to the first aspect of the present invention, the user can know the communication quality of communication from the mobile terminal to the compact base station and thus can take measures to improve the communication quality, such as changing the location to use the mobile terminal.

A second aspect of the present invention provides the compact base station according to the first aspect, wherein the compact base station is disposed at a location where a radio wave transmitted from the mobile terminal and a radio wave transmitted from another mobile terminal communicating with another base station can cause interference.

According to the compact base station according to the second aspect, when interference occurs between a radio wave transmitted from another mobile terminal that performs communication with another base station and a radio wave transmitted from a mobile terminal that performs communication with the compact base station according to the second aspect and accordingly the communication quality of communication from the mobile terminal to the compact base station according to the second aspect deteriorates, by informing of the communication quality, the deterioration in communication quality can be notified to the user.

Therefore, by using the compact base station according to the second aspect, in a situation in which taking measures to improve communication quality such as changing the location to use the mobile terminal is particularly effective, a method for the measures can be informed to the user, and thus, wireless communication convenient for the user is easily provided.

A third aspect of the present invention provides the compact base station according to the first or second aspect, further including improvement method informing means for allowing the output unit to inform of a method for improving the communication quality when the communication quality measured by the measuring means is less than or equal to a predetermined level.

According to the compact base station according to the third aspect, when communication quality measured by the measuring means is less than or equal to the predetermined level, the improvement method informing means allows the output unit to inform of a method for improving the communication quality.

Therefore, the user of the compact base station according to the third aspect not only can know the communication quality of communication from the mobile terminal to the compact base station but also can know a method for improving the communication quality when the communication quality becomes worse. Thus, by performing the improvement method, the user can use communication with improved communication quality.

A fourth aspect of the present invention provides the compact base station according to any one of the first to third aspects, wherein the transmitting and receiving unit can communicate with a plurality of the mobile terminals, and the quality informing means or the improvement method informing means allows the output unit to inform of communication qualities or methods for improving for the respective plurality of mobile terminals.

According to the compact base station according to the fourth aspect, the quality informing means or the improvement method informing means can allow the output unit to inform of communication qualities of uplink communications or methods for improving the communication qualities for the respective plurality of mobile terminals with which the transmitting and receiving unit can communicate.

Therefore, even if communication is performed with the compact base station using the plurality of mobile terminals, communication qualities and methods for improving the communication qualities for the respective mobile terminals can be known. Thus, measures to improve communication quality such as changing the location to use a mobile terminal can be taken on a mobile-terminal-by-mobile-terminal basis.

A fifth aspect of the present invention provides the compact base station according to any one of the first to fourth aspects, wherein the quality informing means or the improvement method informing means generates an instruction signal for allowing the output unit provided in the compact base station to perform informing output, and outputs the generated instruction signal to the output unit.

According to the compact base station according to the fifth aspect, the quality informing means or the improvement method informing means generates an instruction signal for allowing the output unit provided in the compact base station to perform informing output, and outputs the generated instruction signal to the output unit.

Therefore, by a user of the compact base station according to the fifth aspect receiving informing of communication quality or a method for improving the communication quality from the output unit provided in the compact base station, the user can take measures to improve the communication quality such as changing the location to use a mobile terminal that is performing communication.

A sixth aspect of the present invention provides the compact base station according to any one of the first to fourth aspects, wherein the quality informing means or the improvement method informing means generates an instruction signal for allowing the output unit provided in the mobile terminal to perform informing output, and allows the generated instruction signal to be transmitted from the transmitting and receiving unit to the mobile terminal.

According to the compact base station according to the sixth aspect, the quality informing means or the improvement method informing means generates an instruction signal for allowing the output unit provided in the mobile terminal to perform informing output, and allows the generated instruction signal to be transmitted from the transmitting and receiving unit to the mobile terminal.

Therefore, since the user of the compact base station according to the sixth aspect can receive informing of communication quality or a method for improving the communication quality from the output unit provided in a mobile terminal which is performing communication, the user can know the communication quality or the method for improving the communication quality, on the mobile terminal being used. Thus, the user can take measures to improve the communication quality such as changing the location to use the mobile terminal that is performing communication.

A seventh aspect of the present invention provides a program causing a computer mounted on a compact base station having a transmitting and receiving unit that performs wireless communication with a mobile terminal, to function as: measuring means for measuring communication quality of uplink communication from the mobile terminal to the compact base station, based on an uplink signal received by the transmitting and receiving unit from the mobile terminal; and quality informing means for allowing an output unit to inform of the communication quality measured by the measuring means, the output unit performing informing output to a user.

According to the program according to the seventh aspect, by causing a computer mounted on a compact base station having a transmitting and receiving unit that performs wireless communication with a mobile terminal to execute the program, the computer can be caused to function as measuring means for measuring communication quality of uplink communication from the mobile terminal to the compact base station, based on an uplink signal received by the transmitting and receiving unit from the mobile terminal; and quality informing means for allowing an output unit that performs informing output to a user to inform of the communication quality measured by the measuring means.

Therefore, by using the computer having mounted thereon the program according to the seventh aspect of the present invention, the user can know the communication quality of communication from the mobile terminal to the compact base station and thus can take measures to improve the communication quality such as changing the location to use the mobile terminal.

### Advantageous Effects of Invention

According to the present invention, the communication quality of uplink communication in mobile communication can be informed to a user.

### BRIEF DESCRIPTION OF DRAWINGS

FIG. 1 is a diagram schematically showing a configuration of a communication system using a femtocell base station according to an embodiment of the present invention.

FIG. 2 is a block diagram schematically showing a configuration of the femtocell base station according to the embodiment of the present invention.

FIG. 3 is a block diagram schematically showing a configuration of a mobile terminal.

FIG. 4 is a diagram showing an example in which the femtocell base station informs of communication quality in the form of sentences, using a display.

FIG. 5 is a diagram showing an example in which the femtocell base station informs of communication quality in the form of graphics, using the display.

FIG. 6 is a diagram showing an example in which the femtocell base station informs of communication quality using an LED.

FIG. 7 is a diagram showing an example in which the mobile terminal informs of communication quality using a display.

FIG. 8 is a diagram showing an example in which the mobile terminal informs of communication quality using an LED.

FIG. 9 is a diagram showing an example in which the femtocell base station informs of a method for improving communication quality, using the display.

FIG. 10 is a diagram showing an example in which the mobile terminal informs of a method for improving communication quality, using the display.

FIG. 11 is a diagram schematically showing an example of the case in which radio waves from the mobile terminal and another mobile terminal cause interference.

FIG. 12 is a diagram schematically showing a configuration for the case in which the femtocell base station is a general-purpose computer.

### DESCRIPTION OF EMBODIMENTS

An embodiment of the present invention will be described below using the drawings. It is to be noted that those components denoted by the same reference signs in different drawings indicate the same or corresponding components.

A femtocell base station 100 according to an embodiment of the present invention is a compact base station used for a communication system 1 in a mobile communication network.

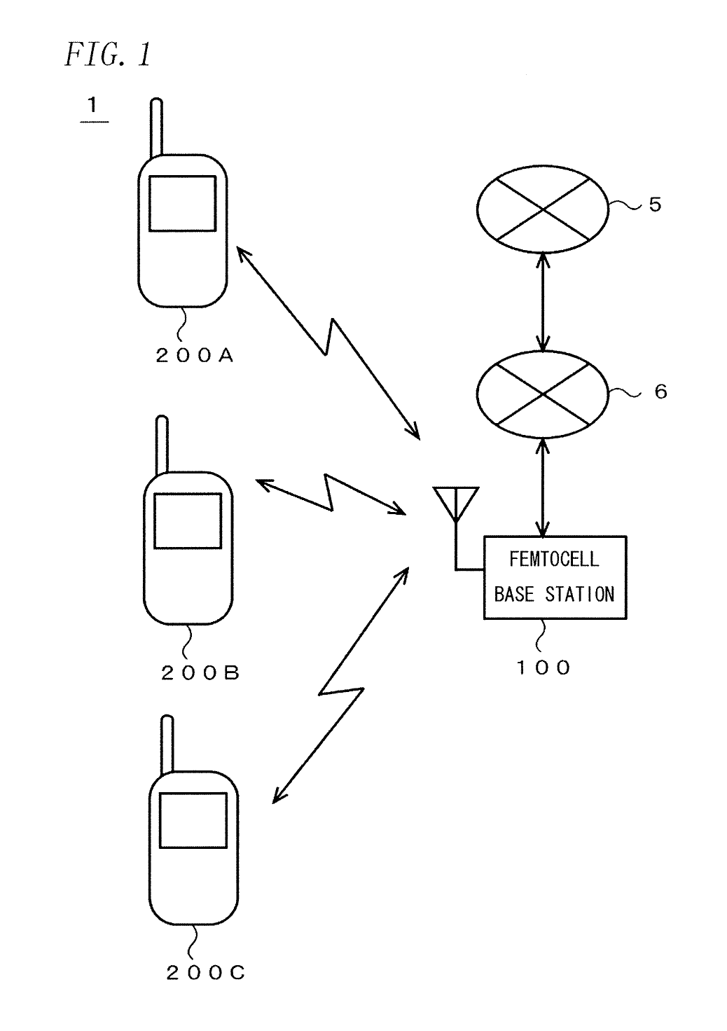

FIG. 1 is a diagram schematically showing a configuration of the communication system 1 having a femtocell base station according to an embodiment of the present invention. The communication system 1 has a core network 5, an IP network 6, the femtocell base station 100 which is a compact base station, and mobile terminals 200 (200A to 200C).

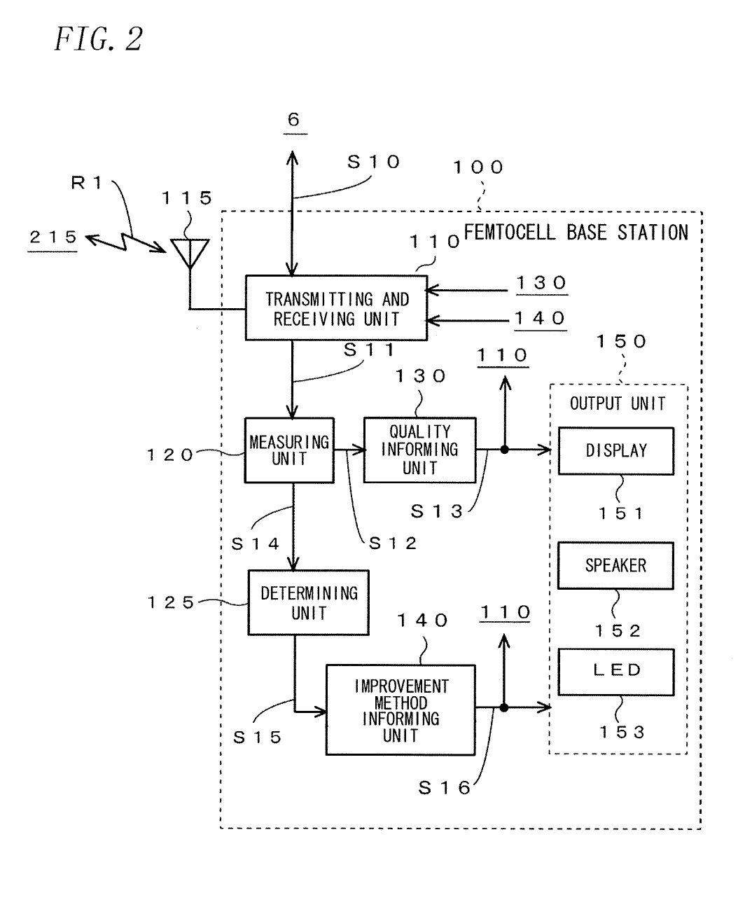

Furthermore, FIG. 2 is a block diagram schematically showing a configuration of the femtocell base station 100 according to the embodiment of the present invention. The femtocell base station 100 includes a transmitting and receiving unit 110, an antenna 115, a measuring unit 120 which is measuring means, a determining unit 125, a quality informing unit 130 which is quality informing means, an improvement method informing unit 140 which is improvement method informing means, and an output unit 150. Furthermore, the output unit 150 has a display 151, a speaker 152, and an LED (Light Emitting Diode) 153.

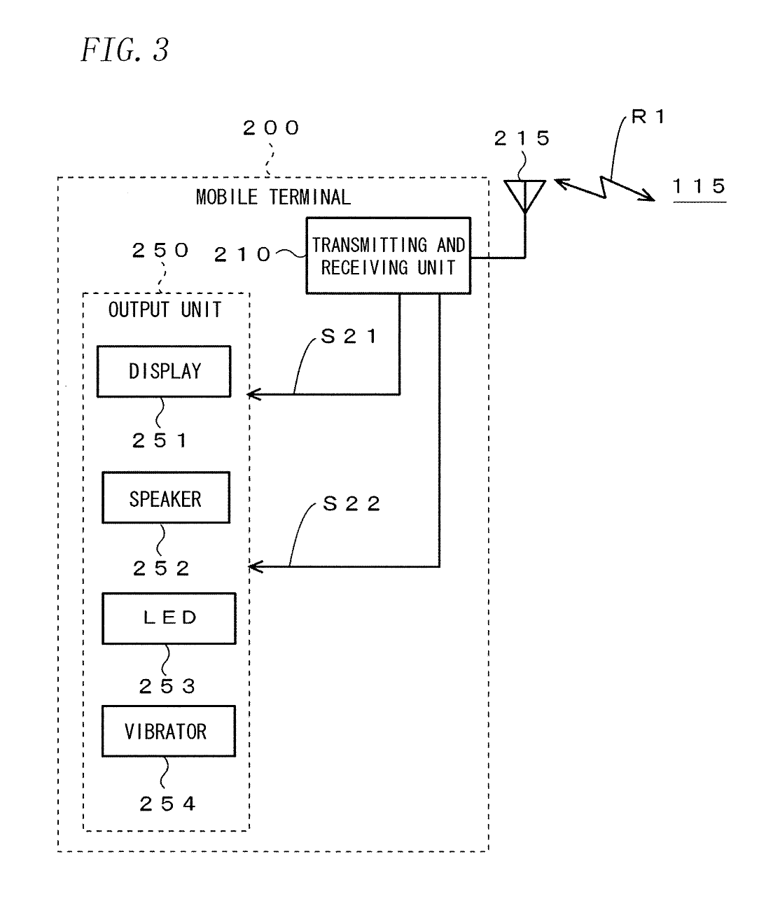

In addition, FIG. 3 is a block diagram schematically showing a configuration of a mobile terminal 200. The mobile terminal 200 includes a transmitting and receiving unit 210, an antenna 215, and an output unit 250. Furthermore, the output unit 250 has a display 251, a speaker 252, an LED 253, and a vibrator 254.

In the communication system 1 having these configurations, the mobile terminals 200 and the femtocell base station 100 perform communication by asymmetric communication using radio waves R1, and furthermore, the femtocell base station 100 performs communication with the core network 5 which is a mobile communication network, through the IP network 6 which is a fixed communication network, using a communication signal S10. Hence, the mobile terminals 200 can perform communication with the mobile communication network through the femtocell base station 100, and the mobile terminals 200 are used as terminals of the mobile communication network.

Next, operation will be described in which the femtocell base station 100 according to the embodiment of the present invention informs of the communication quality of uplink communication which is communication from the mobile terminal 200 to the femtocell base station 100, on the femtocell base station 100.

First, when the transmitting and receiving unit 110 of the femtocell base station 100 receives, using the antenna 115, a wireless communication signal (uplink signal) transmitted by the transmitting and receiving unit 210 of the mobile terminal 200 using an antenna 215, the transmitting and receiving unit 110 outputs to the measuring unit 120 a communication information signal S11 for uplink communication in wireless communication from the mobile terminal 200. The communication information signal S11 includes information for evaluating the quality of wireless communication, e.g., RSSI (Received Signal Strength Indication) or SINR (Signal to Interference and Noise Ratio) in the wireless communication.

Then, the measuring unit 120 measures the communication quality of the uplink communication based on the received communication information signal S11. For the measurement of the communication quality performed by the measuring unit 120, the communication quality may be measured based on the RSSI, SINR, or the like, of a radio wave signal received from the mobile terminal 200 to the femtocell base station 100, which is included in the communication information signal S11.

The measuring unit 120 further outputs the measured communication quality to the quality informing unit 130, as a communication quality signal S12. In addition, for the measurement of the communication quality of the uplink communication, when there are a plurality of mobile terminals 200 that perform communication using the femtocell base station 100, the communication qualities of uplink communications with the respective plurality of mobile terminals 200 are measured separately.

The quality informing unit 130 having received the communication quality signal S12 transmitted from the measuring unit 120 generates a quality informing instruction signal S13 based on the information on the communication quality of the communication from the mobile terminal 200 to the femtocell base station 100 which is included in the communication quality signal S12, and outputs the quality informing instruction signal S13 to the output unit 150.

The output unit 150 having received the quality informing instruction signal S13 informs a user of the communication quality of the uplink communication from the mobile terminal 200 to the femtocell base station 100. In addition, at this time, when there are a plurality of mobile terminals 200 using the femtocell base station 100, the communication qualities of uplink communications for the respective plurality of mobile terminals 200 may be informed individually. (Here, for the mobile terminals 200 to which the communication qualities are informed individually, the mobile terminal 200A is a terminal 1, the mobile terminal 200B is a terminal 2, and the mobile terminal 200C is a terminal 3).

The informing of the user of the communication quality of the uplink communication which is performed by the output unit 150 of the femtocell base station 100 may be performed by display in the form of characters, graphics, etc., using a display, etc.

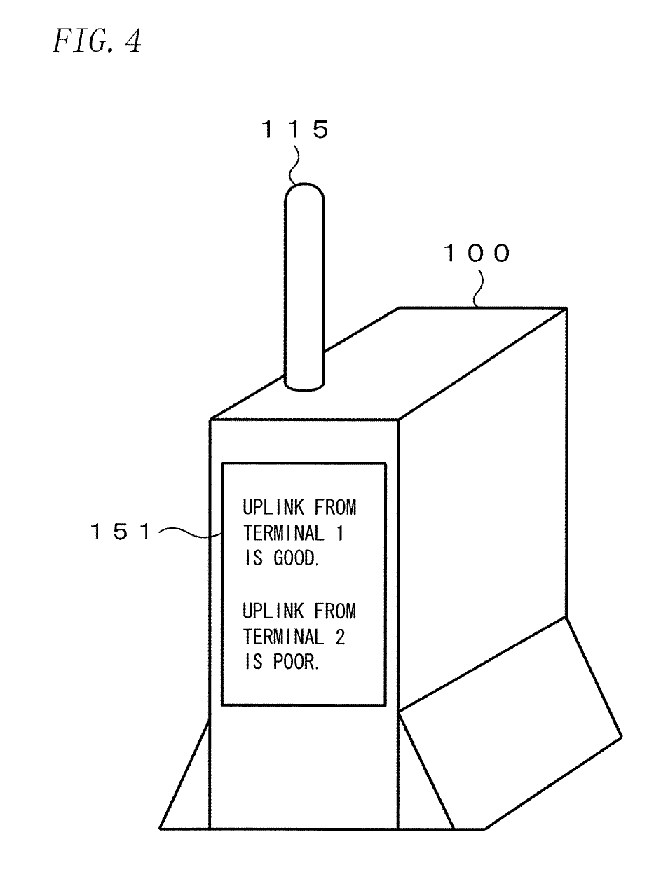

FIG. 4 shows an example in which the femtocell base station 100 informs of the communication quality of the uplink communication in the form of sentences, using the display 151. In FIG. 4, the communication qualities for the terminal 1 and the terminal 2 that perform communication with the femtocell base station 100 are informed in the form of characters.

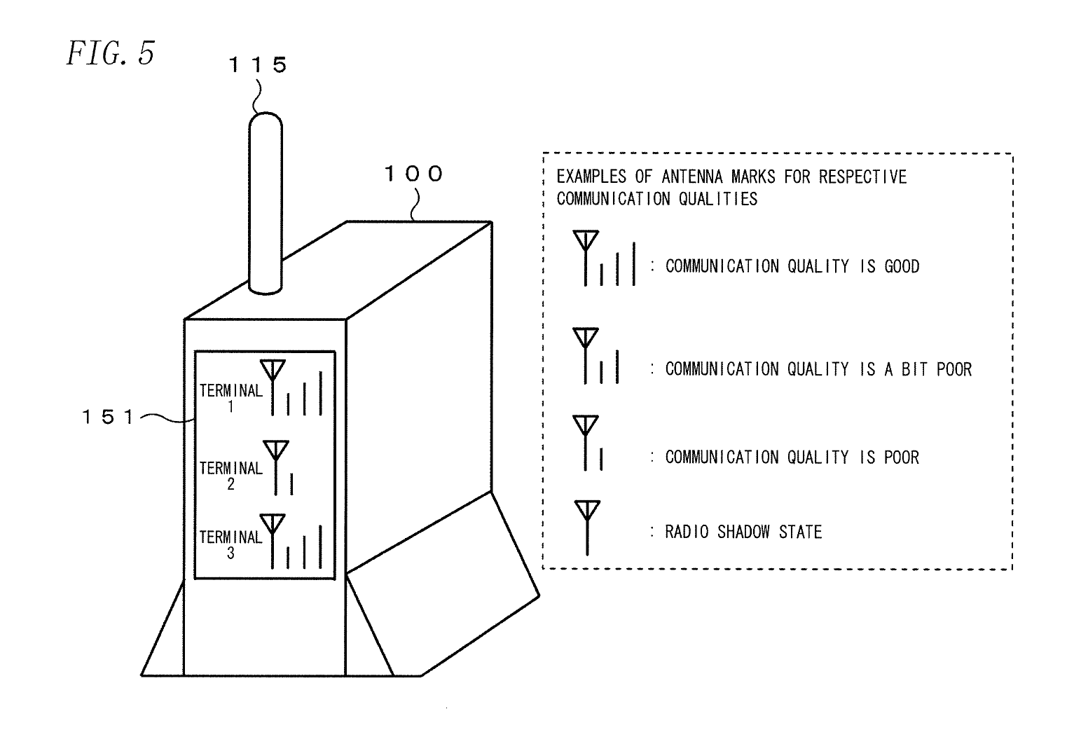

Furthermore, FIG. 5 shows an example in which the femtocell base station 100 informs of the communication qualities of the uplink communications in the form of graphics, using the display 151. In FIG. 5, the case is exemplified in which, for communication qualities for the terminal 1, the terminal 2, and the terminal 3 that perform communication with the femtocell base station 100, the communication qualities of uplink communications are displayed in the form of antenna marks which are commonly used on mobile phones, etc. The antenna marks exemplified in FIG. 5 represent communication quality in three levels by the number of bars displayed in the graphics of the antenna marks. In FIG. 5, in an example in which the antenna marks are displayed on the display 151, the communication quality for the terminal 1 is 3 out of 3 levels, the communication quality for the terminal 2 is 1 out of 3 levels, and the communication quality for the terminal 3 is 3 out of 3 levels, which informs the users that the communication quality for the terminal 2 is poor.

In addition, the informing of the user of the communication quality of the uplink communication which is performed by the output unit 150 of the femtocell base station 100 may be informing in the form of sound using a speaker, etc.

In that case, the output unit 150 informs the user of the communication quality of the uplink communication in the form of sound, using the speaker 152. The informing in the form of sound at this time may be performed by audio guidance such as “the radio wave conditions for the terminal 1 are getting worse” or “the communication quality for the terminal 1 is good”.

Furthermore, the informing of the communication quality of the uplink communication in the form of sound which is performed by the speaker 152 is not limited to audio guidance and may be performed in the form of a beep such as beep sound.

In the informing in the form of a beep, informing may be performed such that, by performing differentiation by the pitch of a beep, the period during which a beep sounds, etc., which terminal among the plurality of mobile terminals 200 the uplink communication is from is determined and whether the communication quality for the terminal is good or poor is distinguished. For example, when the pitch of a beep is high it indicates the communication quality for the terminal 1, and when the pitch of a beep is low it indicates the communication quality for the terminal 2. Furthermore, a distinction may be made such that when the period during which the beep sounds is long the communication sound qualities of uplink communications with the terminals are good, and when the period during which the beep sounds is short the communication sound qualities of uplink communications with the terminals are poor.

In addition, the informing of the user of the communication quality of the uplink communication which is performed by the output unit 150 of the femtocell base station 100 may be performed by lamp display by an LED, etc.

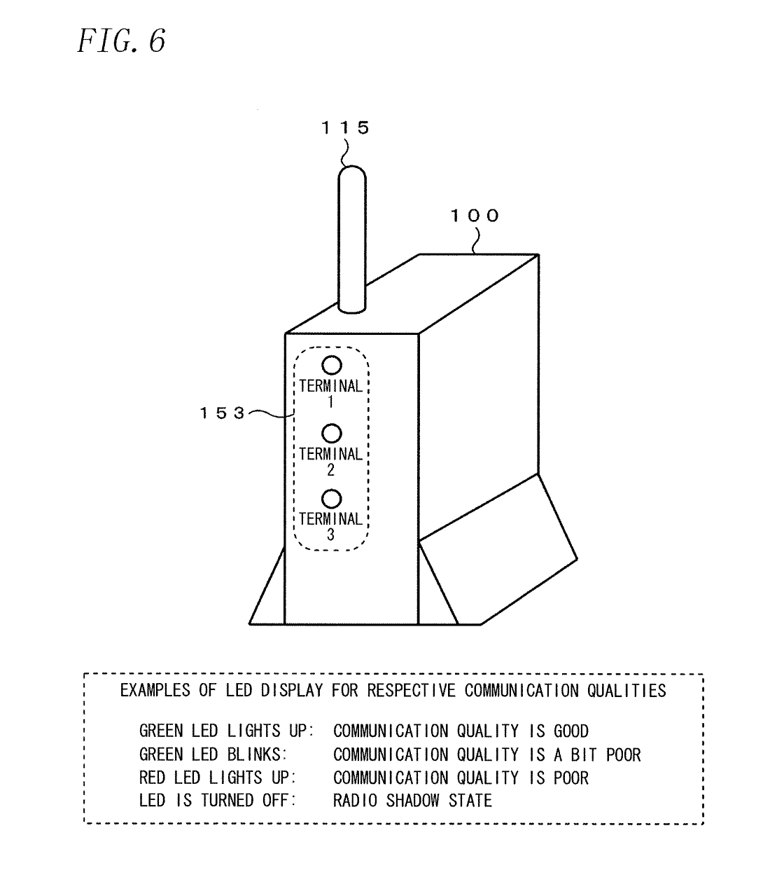

FIG. 6 shows an example in which the femtocell base station 100 informs of the communication qualities of the uplink communications using the LED 153. In FIG. 6, by using LEDs associated with the respective mobile terminals 200 (the terminal 1, the terminal 2, and the terminal 3) performing communication with the femtocell base station 100, the communication qualities of uplink communications from the respective mobile terminals 200 are informed to the respective users by means of how the LEDs light up.

Note that the informing of the user of the communication quality of the uplink communication which is performed by the output unit 150 of the femtocell base station 100 is not limited to those exemplified and may be any as long as the user can recognize that the communication quality of uplink communication from the mobile terminal 200 to the femtocell base station 100 is getting worse.

Next, operation will be described in which the femtocell base station 100 according to the embodiment of the present invention informs of the communication quality of uplink communication, on a mobile terminal 200.

The quality informing unit 130 having received the communication quality signal S12 transmitted from the measuring unit 120 further outputs the generated quality informing instruction signal S13 to the transmitting and receiving unit 110. The transmitting and receiving unit 110 having received the quality informing instruction signal S13 transmitted from the quality informing unit 130 transmits this quality informing instruction to the mobile terminal 200 by wireless communication. For the transmission of the quality informing instruction, when there are a plurality of mobile terminals 200 performing communication using the femtocell base station 100, the quality informing instruction may be transmitted to each of the plurality of mobile terminals 200.

Then, the transmitting and receiving unit 210 of the mobile terminal 200 receives the quality informing instruction using the antenna 215 and outputs a quality informing instruction signal S21 to the output unit 250.

The output unit 250 having received the quality informing instruction signal S21 informs a user of the communication quality of uplink communication from the mobile terminal 200 to the femtocell base station 100.

The informing of the user of the communication quality of the uplink communication which is performed by the output unit 250 of the mobile terminal 200 may be performed by display in the form of characters, graphics, etc., using a display, etc.

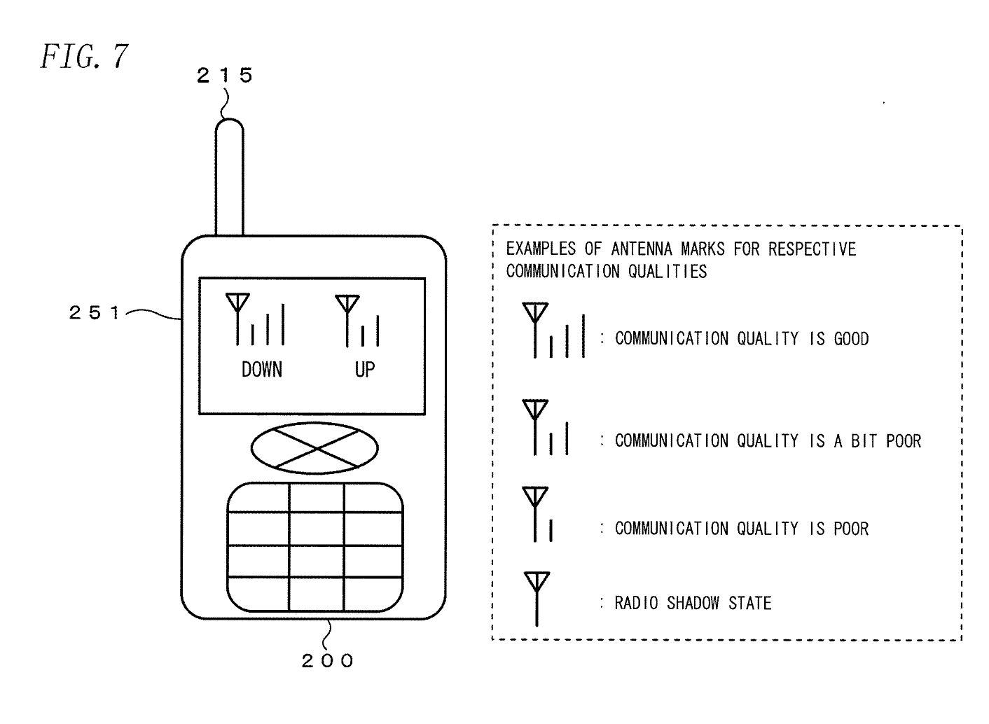

FIG. 7 shows an example in which the mobile terminal 200 informs of the communication quality of uplink communication from the mobile terminal 200 to the femtocell base station 100, using the display 251. In FIG. 7, the case is exemplified in which the communication quality of uplink communication is displayed together with the communication quality of downlink communication in the form of antenna marks which are commonly used on mobile phones, etc. The antenna marks exemplified in FIG. 7 represent communication quality in three levels by the number of bars displayed in the graphics of the antenna marks. In FIG. 7, in an example in which the antenna marks are displayed on the display 251, the downlink communication quality for the mobile terminal 200 is 3 out of 3 levels and the uplink communication quality is 2 out of 3 levels, which informs the user that the uplink communication quality for the mobile terminal 200 is a bit poor.

In addition, the informing of the user of the communication quality of the uplink communication which is performed by the output unit 250 of the mobile terminal 200 may be informing in the form of sound, using a speaker, etc.

In that case, the output unit 250 informs the user of the communication quality of the uplink communication from the mobile terminal 200 to the femtocell base station 100 in the form of sound, using the speaker 252. The informing in the form of sound at this time may be performed by audio guidance such as “the radio wave conditions are getting worse” or “the communication quality is good”. Furthermore, the informing of the communication quality of the uplink communication in the form of sound is not limited to audio guidance and may be performed in the form of a beep such as beep sound. In this case, informing may be performed such that whether the communication quality is good or poor is distinguished by the pitch of a beep, the period during which a beep sounds, etc.

In addition, the informing of the user of the communication quality of the uplink communication which is performed by the output unit 250 of the mobile terminal 200 may be performed by lamp display by an LED, etc.

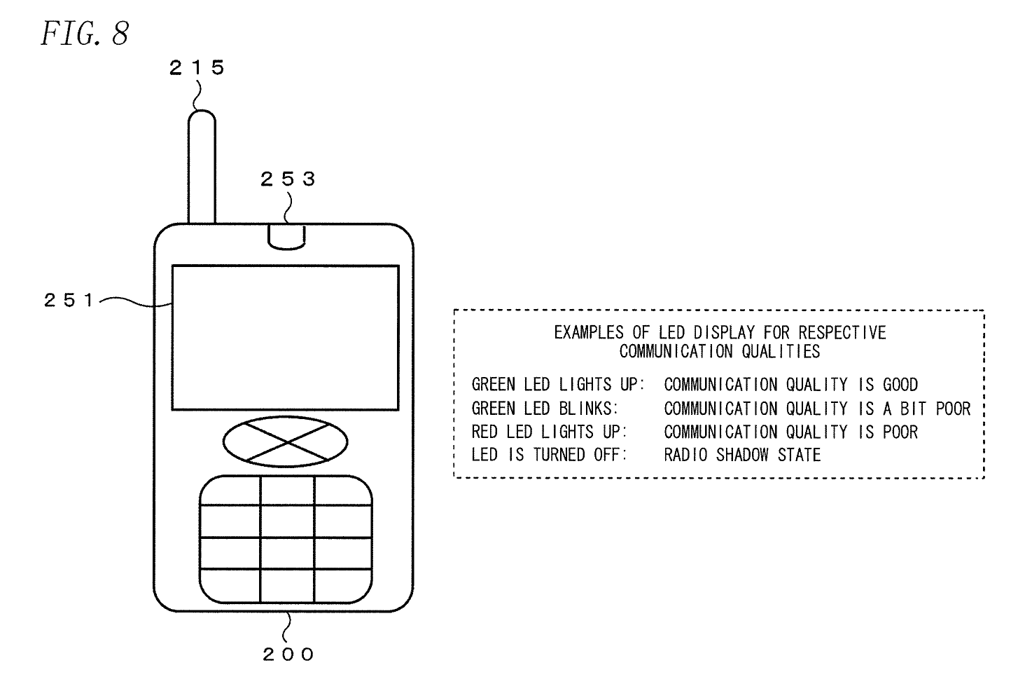

FIG. 8 shows an example in which the mobile terminal 200 informs of the communication quality of the uplink communication, using the LED 253. In an example in FIG. 8, the communication quality of uplink communication to the femtocell base station 100 is informed to the user by means of how the LED 253 lights up.

In addition, the informing of the user of the communication quality of the uplink communication which is performed by the output unit 250 of the mobile terminal 200 may be performed by vibration using a vibrator, etc.

In that case, the output unit 250 informs the user of the communication quality of the uplink communication from the mobile terminal 200 to the femtocell base station 100, by allowing the mobile terminal 200 to vibrate using the vibrator 254. In the informing by vibration at this time, informing may be performed such that whether the communication quality is good or poor is distinguished by the magnitude of the vibration, the frequency of the vibration, etc.

Note that the informing of the user of the communication quality of the uplink communication which is performed by the output unit 250 of the mobile terminal 200 is not limited to those exemplified and may be any as long as the user can recognize that the communication quality of uplink communication from the mobile terminal 200 to the femtocell base station 100 is getting worse.

Note also that the informing of the communication quality of the uplink communication which is performed by the output unit 250 of the mobile terminal 200 may be informing of only communication quality for the mobile terminal 200 or may be informing of communication quality for another mobile terminal 200 using the same femtocell base station 100.

Next, operation will be described in which the femtocell base station 100 according to the embodiment of the present invention informs of a method for improving the communication quality of uplink communication, on the femtocell base station 100.

The result of measurement of the communication quality of the uplink communication which is performed by the measuring unit 120 is also outputted to the determining unit 125, as a communication quality signal S14. The determining unit 125 having received the communication quality signal S14 determines whether to inform of a method for improving the communication quality, based on communication quality information included in the communication quality signal S14.

This determination is made, for example, such that a value relating to the communication quality of the uplink communication from the mobile terminal 200 to the femtocell base station 100, such as RSSI or SINR used for the measurement of the communication quality, is compared with a predetermined threshold value which is a predetermined level, and if the value relating to the communication quality exceeds the predetermined threshold value then it is determined not to inform of a method for improving the communication quality, and if the value relating to the communication quality is less than or equal to the predetermined threshold value then it is determined to inform of a method for improving the communication quality.

Then, the determining unit 125 outputs a determination result signal S15 including information on the result of the determination, to the improvement method informing unit 140. In addition, in this determination, when there are a plurality of mobile terminals 200 using the femtocell base station 100, the communication qualities for the respective mobile terminals 200 may be determined. The results of the determinations in this case are outputted so as to distinguish which determination is for which mobile terminal 200.

Then, when the result of the determination included in the determination result signal S15 indicates that it is determined to perform informing, the improvement method informing unit 140 having received the determination result signal S15 transmitted from the determining unit 125 generates an improvement method informing instruction signal S16 and outputs the improvement method informing instruction signal S16 to the output unit 150.

The output unit 150 having received the improvement method informing instruction signal S16 informs the user of a method for improving the communication quality of the uplink communication from the mobile terminal 200 to the femtocell base station 100.

The informing of the user of a method for improving the communication quality of the uplink communication which is performed by the output unit 150 of the femtocell base station 100 may be performed by display in the form of characters, graphics, etc., using a display, etc.

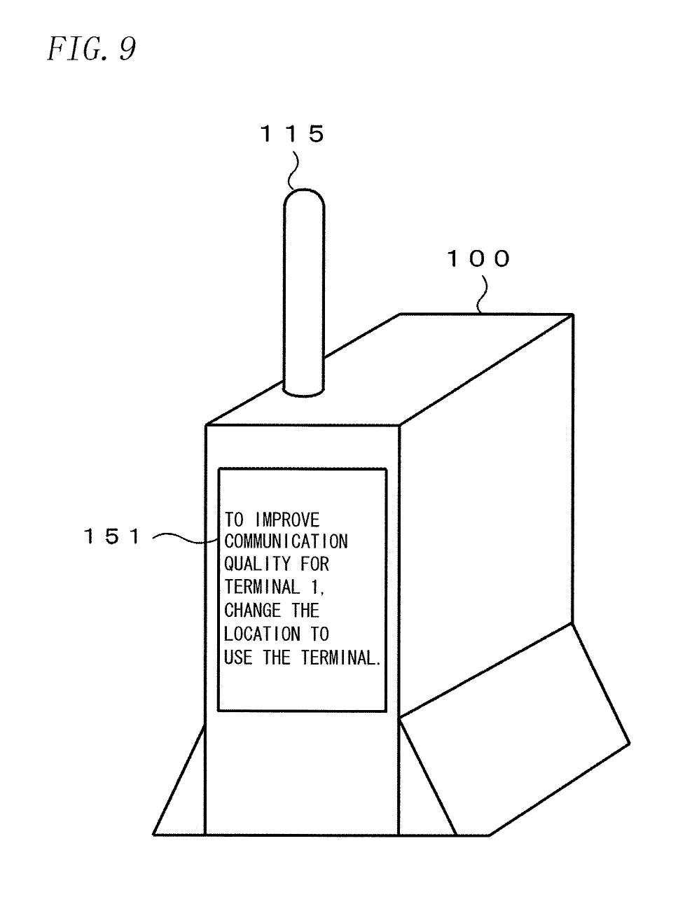

FIG. 9 shows an example in which the femtocell base station 100 informs of a method for improving the communication quality of the uplink communication, using the display 151. In FIG. 9, a method for improving communication quality is displayed on the display 151 in the form of characters, for the terminal 1 having poor communication quality of uplink communication.

In addition, the informing of the user of a method for improving the communication quality of the uplink communication which is performed by the output unit 150 of the femtocell base station 100 may be performed by audio guidance using a speaker, etc.

In that case, the output unit 150 informs the user of a method for improving the communication quality of the uplink communication in the form of audio, using the speaker 152. In the informing in the form of audio at this time, audio guidance such as “change the location to use the terminal 1” or “approach the base station and use the terminal 1” may be provided.

The informing of the user of a method for improving the communication quality of the uplink communication which is performed by the output unit 150 of the femtocell base station 100 may be performed by guidance on any method which is considered to improve the communication quality of wireless communication performed by the mobile terminal 200 and the femtocell base station 100, such as “change the location to use the mobile terminal”, “remove an obstacle present between the base station and the mobile terminal”, and “change the installation location of the base station”.

Note that the informing of the user of a method for improving the communication quality of the uplink communication which is performed by the output unit 150 of the femtocell base station 100 is not limited to those exemplified and may be any as long as a method for improving the communication quality of uplink communication from the mobile terminal 200 to the femtocell base station 100 can be informed to the user.

Next, operation will be described in which the femtocell base station 100 according to the embodiment of the present invention informs of a method for improving the communication quality of uplink communication, on the mobile terminal 200.

The improvement method informing instruction signal S16 generated by the improvement method informing unit 140 is also outputted to the transmitting and receiving unit 110. The transmitting and receiving unit 110 having received the improvement method informing instruction signal S16 transmits an improvement method informing instruction to the mobile terminal 200 by wireless communication. For the transmission of the improvement method informing instruction, when there are a plurality of mobile terminals 200 performing communication using the femtocell base station 100, the improvement method informing instruction may be transmitted to each of the plurality of mobile terminals 200.

Then, the transmitting and receiving unit 210 of the mobile terminal 200 receives the improvement method informing instruction using the antenna 215 and outputs an improvement method informing instruction signal S22 to the output unit 250.

The output unit 250 having received the improvement method informing instruction signal S22 informs the user of a method for improving the communication quality of the uplink communication from the mobile terminal 200 to the femtocell base station 100.

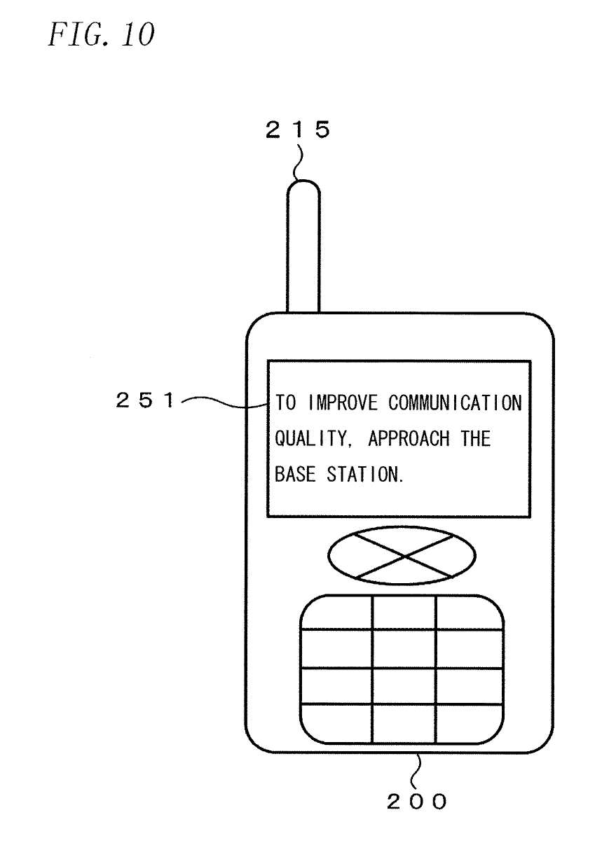

The informing of the user of a method for improving the communication quality of the uplink communication which is performed by the output unit 250 of the mobile terminal 200 may be performed by display in the form of characters, graphics, etc., using a display, etc. FIG. 10 shows an example in which the mobile terminal 200 informs of a method for improving the communication quality of uplink communication from the mobile terminal 200 to the femtocell base station 100, using the display 251.

In addition, the informing of the user of a method for improving the communication quality of the uplink communication which is performed by the output unit 250 of the mobile terminal 200 may be performed by audio guidance using a speaker, etc. In that case, the output unit 250 informs the user of a method for improving the communication quality of uplink communication from the mobile terminal 200 to the femtocell base station 100 in the form of audio, using the speaker 252. In the informing in the form of audio at this time, audio guidance such as “change the location to use the mobile terminal” or “approach the base station and use the mobile terminal” may be provided.

The informing of the user of a method for improving the communication quality of the uplink communication which is performed by the output unit 250 of the mobile terminal 200 may be performed by guidance on any method which is considered to improve the communication quality of wireless communication performed by the mobile terminal 200 and the femtocell base station 100, such as “change the location to use the mobile terminal”, “remove an obstacle present between the base station”, and “change the installation location of the base station”.

Note that the informing of the user of a method for improving the communication quality of the uplink communication which is performed by the output unit 250 of the mobile terminal 200 is not limited to those exemplified and may be any as long as a method for improving the communication quality of uplink communication from the mobile terminal 200 to the femtocell base station 100 can be informed to the user.

Note also that the informing of a method for improving the communication quality of the uplink communication which is performed by the output unit 250 of the mobile terminal 200 may be informing of only a method for improving communication quality for the mobile terminal 200 or may be informing of a method for improving communication quality for another mobile terminal 200 using the same femtocell base station 100.

As described above, with the femtocell base station 100 according to the embodiment of the present invention, the communication quality of uplink communication in wireless communication from a mobile terminal 200 to the femtocell base station 100 can be informed to a user.

In addition, when the communication quality of the uplink communication is poor, a method for improving the communication quality of the uplink communication is also informed to the user. Thus, even though the user does not have knowledge of wireless communication technologies, the user can improve the communication quality of uplink communication in wireless communication from the mobile terminal 200 to the femtocell base station 100, by following the informing of the improvement method. Therefore, the user of the mobile terminal 200 can perform wireless communication with improved communication quality and increased convenience.

In addition, a mobile terminal 200 using the femtocell base station 100 according to the embodiment of the present invention is assumed to be used in a location where the mobile terminal 200 causes radio wave interference with another mobile terminal using another base station.

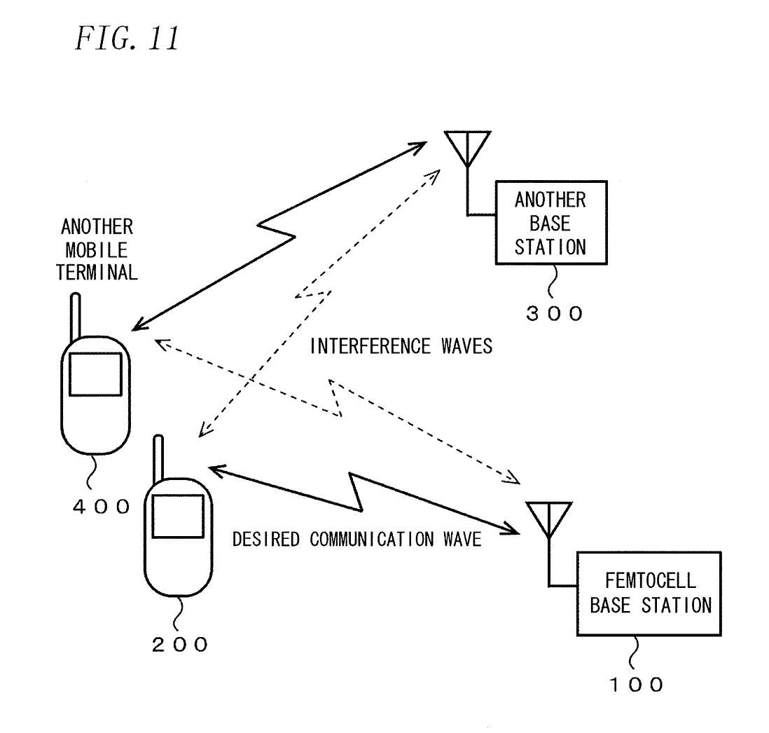

FIG. 11 schematically shows an example of the case in which radio waves from a mobile terminal 200 and a mobile terminal 400 cause interference. In FIG. 11, when another mobile terminal 400 performing communication with another base station 300 is present around the mobile terminal 200, a communication radio wave between the mobile terminal 200 and a femtocell base station 100 may cause radio wave interference with a communication radio wave between another base station 300 and another mobile terminal 400 and accordingly the communication quality of communication between the mobile terminal 200 and the femtocell base station 100 may particularly deteriorate.

In such a case, by the femtocell base station 100 according to the embodiment of the present invention informing a user of the communication quality of uplink communication, the user can grasp the current communication quality. Furthermore, when the communication quality becomes worse, the femtocell base station 100 according to the embodiment of the present invention informs of a method for improving the communication quality and thus the user can easily improve the communication quality. Note that another base station 300 as used herein may be a macrocell base station or a femtocell base station.

Note that the femtocell base station 100 according to the embodiment of the present invention may be one having a general-purpose computer mounted thereon.

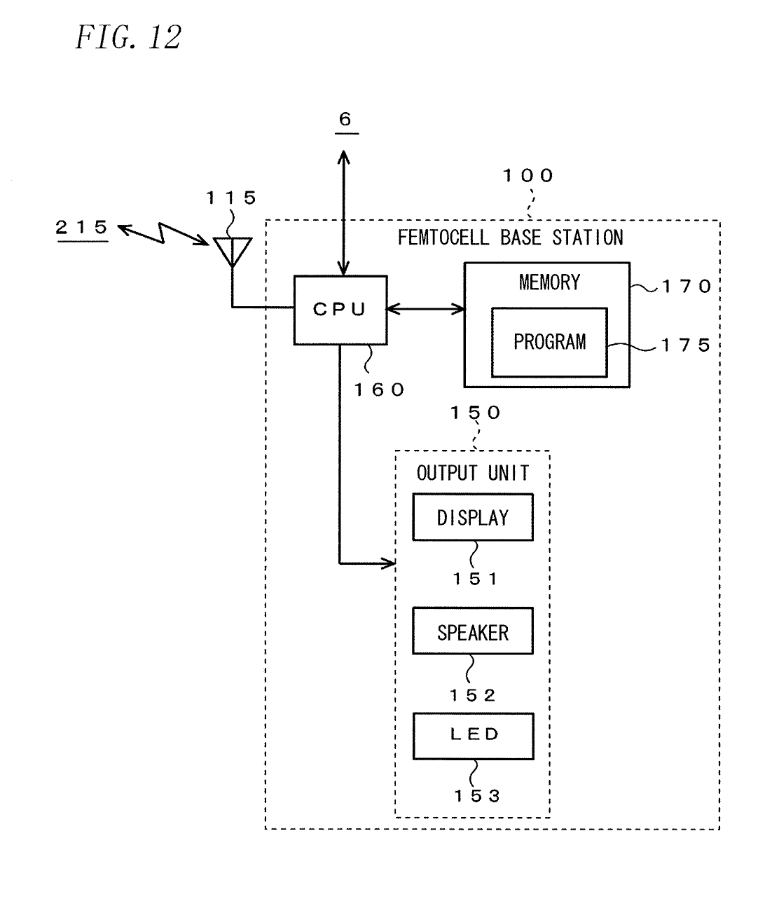

FIG. 12 is a diagram schematically showing a configuration for the case in which the femtocell base station 100 has a general-purpose computer. The femtocell base station 100 includes a CPU (Central Processing Unit) 160 and a memory 170 serving as a recording medium. By the CPU 160 loading and executing a program 175 held in the memory 170, various functions of the femtocell base station 100 such as those shown in FIG. 2 can be implemented. Note that in FIG. 12 depiction of the transmitting and receiving unit 110 is omitted.

In addition, although, in the embodiment of the present invention, description is made exemplifying the case in which a compact base station is a femtocell base station, in the present invention a compact base station is not limited to a femtocell base station and may be, for example, a picocell base station.

In addition, for the communication quality of uplink communication to be informed, not only informing for uplink communication alone but also informing of collective communication quality obtained by comprehensively evaluating the communication qualities of uplink communication and downlink communication which are asymmetric may be performed. Furthermore, although the case is exemplified in which there are three mobile terminals performing communication with a compact base station, it is not intended to limit the number of mobile terminals using a compact base station in the present invention.

It is to be noted that the embodiment disclosed herein is to be considered in all respects as illustrative and not restrictive. The scope of the present invention is indicated by the appended claims rather than by the foregoing meaning, and all changes which come within the meanings and range of equivalency of the claims are therefore intended to be embraced therein.

### REFERENCE SIGNS LIST

1: COMMUNICATION SYSTEM
5: CORE NETWORK
6: IP NETWORK
100: FEMTOCELL BASE STATION
120: MEASURING UNIT
130: QUALITY INFORMING UNIT
140: IMPROVEMENT METHOD INFORMING UNIT
160: CPU
170: MEMORY
175: PROGRAM
200: MOBILE TERMINAL

1. A compact base station used by a user of a mobile terminal, the compact base station comprising:
a transmitting and receiving unit that performs communication with a core network and wireless communication with the mobile terminal, the core network being a mobile communication network and the mobile terminal being used as a terminal of the mobile communication network;
measuring means for measuring communication quality of uplink communication from the mobile terminal to the compact base station, based on an uplink signal received by the transmitting and receiving unit from the mobile terminal; and
quality informing means for allowing an output unit to inform of the communication quality measured by the measuring means, the output unit performing informing output to the user.

2. The compact base station according to claim 1, wherein the compact base station is a femtocell base station.

3. The compact base station according to claim 1, further comprising improvement method informing means for allowing the output unit to inform of a method for improving the communication quality when the communication quality measured by the measuring means is less than or equal to a predetermined level.

4. The compact base station according to claim 1, wherein
the output unit is provided in the compact base station, and
the quality informing means or the improvement method informing means generates an instruction signal for allowing the output unit of the compact base station to perform informing output, and outputs the generated instruction signal to the output unit.

5. The compact base station according to claim 3, wherein the informing of the improvement method by the output unit is performed by guiding the user to:
change a location to use the mobile terminal;
remove an obstacle present between the compact base station and the mobile terminal; or
change an installation location of the compact base station.

6. The compact base station according to claim 1, wherein
the output unit is also provided in the mobile terminal, and
the quality informing means or the improvement method informing means generates an instruction signal for allowing the output unit of the mobile terminal to perform informing output, and allows the generated instruction signal to be transmitted from the transmitting and receiving unit to the mobile terminal.

7. A program causing a computer mounted on a compact base station used by a user of a mobile terminal and having a transmitting and receiving unit that performs communication with a core network and wireless communication with the mobile terminal, the core network being a mobile communication network and the mobile terminal being used as a terminal of the mobile communication network, to function as:
measuring means for measuring communication quality of uplink communication from the mobile terminal to the compact base station, based on an uplink signal received by the transmitting and receiving unit from the mobile terminal; and
quality informing means for allowing an output unit to inform of the communication quality measured by the measuring means, the output unit performing informing output to the user.
